(19) United States
(12) Patent Application Publication
(10) Pub. No.: US 2006/0107475 A1
(43) Pub. Date: May 25, 2006

(54) Paint roller assembly with a power actuated roller support

(76) Inventor: Albert W. Swenson, Trumbull, CT (US)

Correspondence Address: JAMES RAY & ASSOCIATES, 2640 PITCAIRN ROAD, MONROEVILLE, PA, 15146, US

(21) Appl. No.: 11/281,871

(22) Filed: Nov. 17, 2005

Related U.S. Application Data
(60) Provisional application No. 60/630,397, filed on Nov. 23, 2004.

(51) Int. Cl. B05C 17/02

(52) U.S. Cl. 15/97.1; 15/103.5; 15/98

(57) ABSTRACT

A roller assembly for uniformly applying liquid onto a roller surface includes a handle having a hand grip portion and a roller attachment portion, a substantially cylindrical roller support, having each of a predetermined diameter and predetermined length and which is disposed adjacent the roller attachment portion. A drive member is engageable with the roller attachment portion of the handle and with the roller support and operable for rotating the roller support in one direction. A switch is coupled to a power source and to the drive member for controlling operation thereof.

### CROSS-REFERENCE TO RELATED APPLICATIONS

This application is related to and claims priory from Provisional Patent Application Ser. No. 60/630,397 filed Nov. 23, 2004.

### FIELD OF THE INVENTION

The present invention relates, in general, to a paint roller and, more particularly, this invention relates to a paint roller having a power actuated roller support and, yet more particularly, the instant invention relates to a paint roller having a power actuated roller support for uniformly applying paint onto a paint roller mounted on such power actuated roller support.

### BACKGROUND OF THE INVENTION

As is generally well known in the art, loading of paint onto a surface of a conventional paint roller requires dipping such roller into a body of paint, manually rotating the roller within such body of paint to apply the paint to its entire surface and then removing paint excess by rotating the roller on the ribbed surface of a paint tray or perforated baffle of the paint bucket. The manual rotation of the roller is achieved by reciprocally moving the paint roller assembly in a linear direction which places undesired stresses onto the hand, arm and shoulder of the user, frequently resulting in fatigue experienced by the user during the painting process.

### SUMMARY OF THE INVENTION

The invention provides a roller assembly for uniformly applying liquid onto a roller surface. Such roller assembly includes a handle having a hand grip portion and a roller attachment portion. A substantially cylindrical roller support, having each of a predetermined diameter and predetermined length, is disposed adjacent the roller attachment portion. A drive member is engageable with the roller attachment portion of the handle and with the roller support and operable for rotating the roller support in one direction. A switch is coupled to a power source and to the drive member for controlling operation thereof.

To uniformly apply liquid which is generally disposed in a container onto the roller surface, the roller assembly is positioned to place a portion of the roller surface at a predetermined depth below the surface of the liquid. The drive member us then activated by the switch to rotate the roller which uniformly applies such liquid onto the roller surface. When the liquid is applied onto the roller surface, the drive member is deactivated by the switch.

### OBJECTS OF THE INVENTION

It is, therefore, one of the primary objects of the present invention to provide a paint roller assembly for uniformly applying paint onto a paint roller.

Another object of the present invention is to provide a paint roller assembly for uniformly applying paint onto a paint roller which significantly reduces fatigue experienced by the user during the painting process.

Yet another object of the present invention is to provide a paint roller assembly for uniformly applying paint onto a paint roller which incorporates a power actuated roller support.

A further object of the present invention is to provide a paint roller assembly for uniformly applying paint onto a paint roller which has an electrically operable roller support.

Yet, a further object of the present invention is to provide a paint roller assembly for uniformly applying paint onto a paint roller which includes a rechargeable power source.

In addition to the several objects and advantages of the present invention which have been described with some degree of specificity above, various other objects and advantages of the invention will become more readily apparent to those persons who are skilled in the relevant art from the following more detailed description of the invention, particularly, when such description is taken in conjunction with the attached drawing Figures and with the appended claims.

### BRIEF DESCRIPTION OF THE DRAWINGS

FIG. 1 is a perspective view of a paint roller assembly of the invention;

FIG. 2 is a cross-sectional view of the paint roller assembly of the invention along lines 2-2 of FIG. 1;

FIG. 3 is a partial cross-sectional view of the paint roller assembly along lines 3-3 of FIG. 2;

FIG. 4 is a perspective view of a paint roller assembly of the invention, particularly showing use of a handle extension;

FIG. 5 is a perspective view of a paint roller assembly of the invention in combination with a paint tray;

FIG. 6 is a perspective view of a charging system according to one embodiment of the invention;

FIG. 7 is a plan view of a charging system according to another embodiment of the invention; and

FIG. 8 is a perspective view of a charging system according to yet another embodiment of the invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

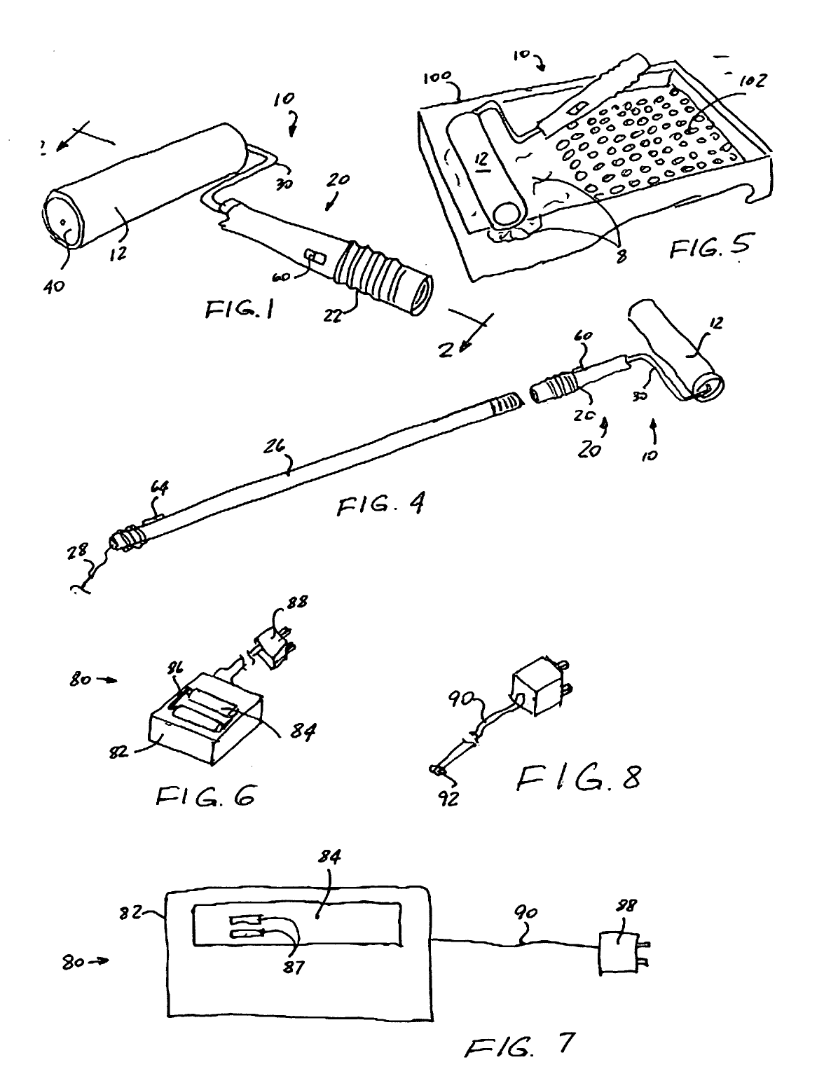

Reference is now made, to FIGS. 1-8, wherein there is shown a paint roller assembly, generally designated 10, which comprises a handle, generally designated 20, including a hand grip portion 22 and a roller attachment portion 30 extending from one end of the grip portion 22. A substantially cylindrical roller support 40 having each of a predetermined diameter and predetermined length is disposed adjacent the roller attachment portion 30 and is used for mounting a paint roller 12 thereon for rotation therewith. A pair of members 42 and 44 may be provided for closing opposed ends of the roller support 40.

Now in particular reference to FIG. 2, there is a drive means, generally designated 50, which is engageable with the roller attachment portion 30 of the handle 20 and with the roller support 40 and operable for rotating the roller support 40 in a first direction and enabling manual rotation of the roller support 40 in a second direction being opposite to the first direction. The drive means 50 may be mounted external to the roller support 40 and, preferably, the drive means 50 is mounted internal to the roller support 40. In the presently preferred embodiment, the drive means 50 includes a motor 52 attached to a distal end 32 of the roller attachment portion 30 and means 56 connected to an output shaft 54 of the motor 52 and substantially engaged with a predetermined portion of the roller support 40 for rotating it when the motor 52 is activated. Accordingly, means 60 is coupled to the drive means 50 for controlling operation of the drive means 50 and, more particularly, at least activating the motor 52. The motor 52 may be operable by one of electrical and fluid power. Preferably, the motor 52 is operable by electric power and the assembly 10 further includes a power source, generally designated 70, which is coupled to the control means 60 for supplying the electrical power to the drive means 50 and, more particularly, to the electrical motor 52.

The means 56 may be at least one disk member 56 frictionally and directly engaging inner surface 46 of the roller support 40, as best shown in FIG. 2, whereby a rotational motion generated by the motor 52 and transferred to the disk member 56 through the motor shaft 52 enables such disk member 56 to rotate the roller support 40 and the paint roller 12 mounted thereon. Alternatively, such means 56 may be at least one splined member 56 meshing with a complimentary splined portion 48 disposed on the inner surface 46 of the roller support 40, as best shown in FIG. 3. It will be appreciated that such splined member 56 may be a gear 56.

When such drive means 50 is of an electric type, the control means 60 is a switch 60 manually operable between a first position for enabling supply of electrical power to the motor 52 and a second position for discontinuing supply of such power. The switch 60 may be one of any well known switch types such as pushbutton, rocker, slider, membrane and the like. It will be apparent to those skilled in the art that when such switch 60 is of a pushbutton or membrane type, the first and second positions will be identical to each other and activation and deactivation of the motor 52 will be by a consecutive operation of such switch 60.

Advantageously, the roller attachment portion 30 is of a hollow tubular type to enable passage of at least one wire 62 therethrough for coupling the control means 60 to the motor 52.

It will be appreciated that the drive means 50 and the switch means 60 may be adapted for rotating the roller support 40 in such second direction when the electrical power is supplied from the power source 70.

The power source 70 is preferably at least one battery 72 disposed in the grip portion 22 of the handle 20. It is further preferred that such power source 70 is at least one rechargeable battery 72. Accordingly, the assembly 10 may be provided with a recharging means, generally designated 80, for recharging the at least one rechargeable battery 72.

In a particular reference to FIG. 6, the recharging means 80 may include a housing 82 having a cradle 84, at least one pair of electrical contacts 86 disposed within the cradle 84 for engagement with electrical contacts of the at least one battery 72 when such at least one battery 72 is placed into the cradle 84 and an adapter 88 for connecting the at least one pair of electrical contacts to an electrical outlet (not shown).

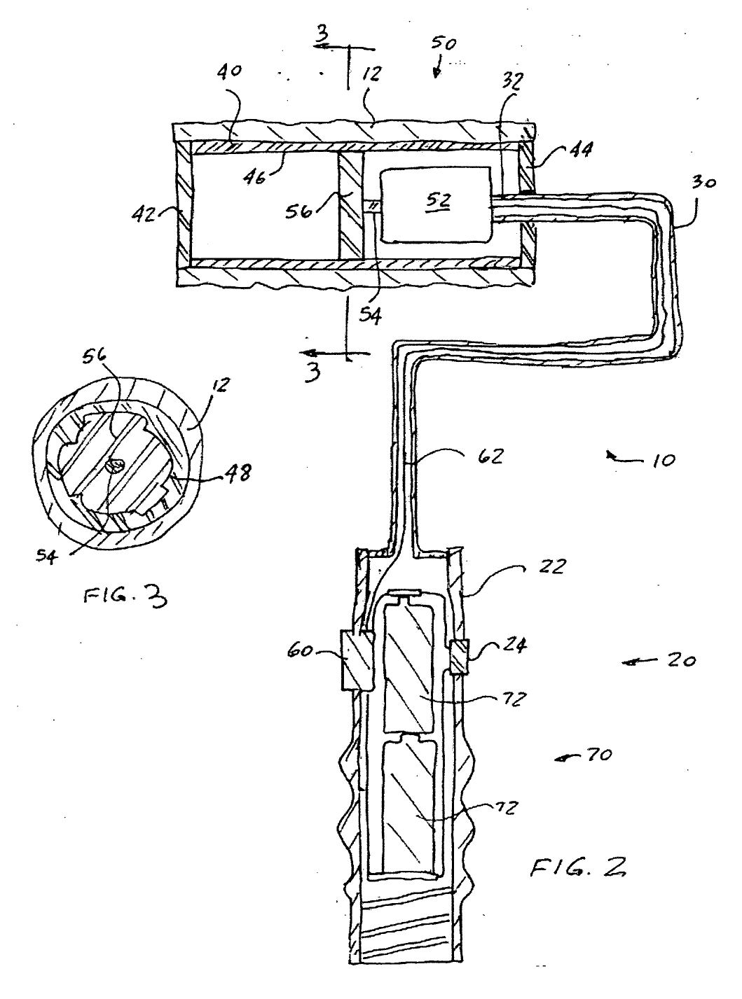

Alternatively, as shown in FIG. 7, such cradle 84 may be adapted for receiving at least a portion of the handle 20 having at least one electrical contact 24 accessible from the exterior surface of the grip portion 22 for engagement with at least one electrical contact 87 disposed within the cradle 84.

Yet alternatively, as shown in FIG. 8, the recharging means 80 may include an adapter 88 engageable with the electrical outlet (not shown), at least one wire 90 extending from the adapter 88 and at least one electrical contact 92 terminating at the distal end of the at least one wire 90 for coupling with an electrical contact 24 disposed within the handle 20 and which is coupled to the at least one battery 72.

Now in reference to FIG. 4, the hand grip portion 22 of the handle 20 may be adapted for connection to at least one handle extension member 26. Advantageously, such at least one handle extension member 26 may include a second control means 64 disposed therein and coupled to the power source 70 for operating the drive means 50 when the at least one handle extension member 26 is connected to the hand grip portion 22 of the handle 20. The handle extension 26 may be adapted with a well known cord 28 for direct connection to the electrical outlet (not shown).

The operation of the assembly 10 is illustrated in FIG. 5 in combination with a well known paint container 100, such as a paint tray 100, having a predetermined amount of paint 8 disposed therein. The roller assembly 10 is stationary positioned in order to submerge a portion of the paint roller 12 at a predetermined depth below the surface of the paint 8, activating the drive means 50 with the control means 60 to rotate the roller 12 which uniformly applies the paint 8 onto a surface thereof and then using the control means 60 to deactivate the drive means 50. When required, any excess of paint 8 may be removed by manually rotating the roller 12 on the ribbed surface portion 102 of the paint tray 100.

Although the present invention has been shown in terms of the roller assembly 10 utilized for uniformly applying paint onto a paint roller surface, it will be apparent to those skilled in the art, that the present invention may be utilized in other applications requiring uniform application of a liquid or paste onto a roller surface. For example, such roller assembly 10 may be utilized for applying liquid paste onto a roller surface for depositing such liquid paste onto wall paper.

Furthermore, the drive means 50 may be provided with a quick release member to disengage such drive means 50 from the roller support 40 and enable a free rotation thereof.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A roller assembly comprising:
(a) a handle having a hand grip portion and a roller attachment portion;
(b) a substantially cylindrical roller support, having each of a predetermined diameter and predetermined length, disposed adjacent said roller attachment portion;
(c) a drive means engageable with said roller attachment portion of said handle and with said roller support and operable for rotating said roller support in one direction; and
(d) means coupled to a power source and to said drive means for controlling operation of said drive means.

2. The assembly, according to claim 1, wherein said drive means is one of externally and internally disposed with respect to said roller support.

3. The assembly, according to claim 1, wherein said drive means includes a motor attached to a distal end of said roller attachment portion and means connected to an output shaft of said motor and substantially engaged with a predetermined portion of said roller support for rotating it when said motor is activated by said control means.

4. The assembly, according to claim 3, wherein said motor is operable by one of electrical and fluid power.

5. The assembly, according to claim 4, wherein said motor is operable by electrical power and said assembly further includes said power source coupled to said control means for supplying said electrical power to said drive means.

6. The assembly, according to claim 5, wherein said power source is at least one battery disposed in said grip portion of said handle.

7. The assembly, according to claim 6, wherein said at least one battery is one of rechargeable and disposable.

8. The assembly, according to claim 6, wherein said power source is at least one rechargeable battery and said assembly includes a recharging means for recharging said at least one rechargeable battery.

9. The assembly, according to claim 8, wherein said recharging means includes a housing having a cradle, at least one pair of electrical contacts disposed within said cradle for engagement with electrical contacts of said at least one rechargeable battery when said at least one rechargeable battery is placed into said cradle and an adapter for connecting said at least one pair of electrical contacts to an electrical outlet.

10. The assembly, according to claim 8, wherein said recharging means includes a housing having a cradle, at least one first electrical contact disposed within said cradle for engagement with at least one second electrical contact disposed on a predetermined portion of said handle when said predetermined portion is placed into said cradle and an adapter for connecting said at least one pair of electrical contacts to an electrical outlet.

11. The assembly, according to claim 8, wherein said recharging means includes an adapter engageable with an electrical outlet, at least one wire extending from said adapter and at least one first electrical contact connected to a distal end of said at least one wire for coupling to a second electrical contact disposed within said handle and coupled to said at least one rechargeable battery.

12. The assembly, according to claim 1, wherein said drive means enables manual rotation of said roller support in a second direction being opposite to said first direction.

13. The assembly, according to claim 1, wherein said control means is a switch manually operable between a first position for enabling supply of said power to said drive means and a second position for discontinuing supply of said power.

14. The assembly, according to claim 1, wherein said assembly further includes a roller mounted onto said roller support for rotation therewith.

15. The assembly, according to claim 1, wherein said assembly further includes a pair of members closing opposed ends of said roller support.

16. The assembly, according to claim 1, wherein said hand grip portion of said handle is adapted for connection to at least one handle extension member.

17. The assembly, according to claim 16, wherein said at least one handle extension member includes a second control means for operating said drive means when said at least one handle extension member is connected to said hand grip portion.

18. A method for uniformly applying liquid onto a roller surface, said method comprising the steps of:
(a) providing a roller assembly including a handle having a hand grip portion and a roller attachment portion, a substantially cylindrical roller support disposed adjacent said roller attachment portion, a roller mounted onto said roller support for rotation therewith, a drive means engageable with said roller attachment portion of said handle and with said roller support and operable for rotating said roller support in one direction and means coupled to a power source and to said drive means for controlling operation of said drive means;
(b) providing a container having a predetermined amount of liquid disposed therein;
(c) positioning said roller assembly to submerge a portion of said surface of said roller at a predetermined depth below a surface of said liquid;
(d) activating said drive means with said control means to rotate said roller for uniform application of said liquid onto said surface of said roller; and
(e) deactivating said drive means with said control means when said liquid is applied onto said surface of said roller.

19. The method, according to claim 18, wherein said method further includes a step of removing excess liquid from said roller surface.

20. The method, according to claim 18, wherein said liquid is paint.
